(19) United States
(12) Patent Application Publication
(10) Pub. No.: US 2015/0291357 A1
(43) Pub. Date: Oct. 15, 2015

(54) ROBOTIC PICKUP POINT FOR ORDER FULFILLMENT SYSTEM

(71) Applicant: Sergey N. RAZUMOV, Moscow (RU)

(72) Inventor: Sergey N. RAZUMOV, Moscow (RU)

(21) Appl. No.: 14/251,828

(22) Filed: Apr. 14, 2014

(51) Int. Cl. B65G 1/137; B65G 1/04

(52) U.S. Cl. CPC B65G 1/1373; B65G 1/0492

(57) ABSTRACT

A retail facility for enabling customers to pick up products including perishable items has a storage system for storing containers arranged in multiple rows at various horizontal levels with respect to ground. The storage system includes a first storage section for storing containers with products at a first temperature and a second storage section for storing containers with products at a second temperature higher than the first temperature. The first storage section is covered with a first thermal insulating cover. A transportation device is configured for moving along one or more horizontal rails arranged above the first storage section. The rails are supported by vertical support elements arranged outside of the first thermal insulating cover. The transportation device is configured for taking one or more containers stored in the storage system and delivering the containers to a selected destination.

### TECHNICAL FIELD

This disclosure relates to retail logistics, and more particularly, to pickup points provided to enable customers of an order fulfillment system to pick up ordered products including food and other perishable items, and arranged to store the ordered products at various temperatures.

### BACKGROUND ART

An order fulfillment process is initiated when a customer submits an order for products selected, for example, on a Web site of a company. The company's warehouse notified about a new order prepares the order and ships it to the customer. Instead of shipping the order to the customer, retailers with a network of physical locations or pickup points may make the order available for pickup at a location convenient for the customer. This saves customers money on shipping, and also makes it easier for them to return unsatisfactory products.

However, conventional pickup points are not able to store perishable products subject to decay or spoilage, such as food products or chemical products. Perishable products require storage at different temperatures. For example, frozen seafood and meat require storage in freezing chambers. Fresh fruits and vegetables, fresh seafood and meat, and other perishable items may require refrigeration at various temperatures.

Therefore, it would be desirable to provide a pickup point in which perishable products can be stored at desired temperatures.

Moreover, to reduce cost, it would be desirable to operate the pickup points using robotic devices with little or no direct human control.

### SUMMARY OF THE DISCLOSURE

In accordance with one aspect, the present disclosure offers a retail facility for enabling customers to pick up products including perishable items. The retail facility has a storage system for storing containers arranged in multiple rows at various horizontal levels with respect to ground. The storage system includes a first storage section for storing containers with products at a first temperature and a second storage section for storing containers with products at a second temperature higher than the first temperature. The first storage section is covered with a first thermal insulating cover.

A transportation device is configured for moving along one or more horizontal rails arranged above the first storage section. The rails are supported by vertical support elements arranged outside of the first thermal insulating cover. The transportation device is configured for taking one or more containers stored in the storage system and delivering the containers to a selected destination.

The transportation device includes a frame movable along the horizontal rails and a movable platform configured to move down with respect to the frame so as to take one or more containers arranged at horizontal levels below the horizontal rails.

In an exemplary embodiment, the storage system may further include a third storage section for storing containers with products at a third temperature higher than the first temperature but lower than the second temperature.

The third section may be arranged below the horizontal rails, and may be covered with a second thermal insulating cover. The vertical support elements for supporting the horizontal rails may be arranged outside of the second thermal insulating cover.

The movable platform may be further configured to move up with respect to the frame so as to take one or more containers arranged at horizontal levels above the horizontal rails.

The first and/or second thermal insulating cover may include an opening on top of the cover to allow the movable platform to enter the first and/or third storage section. A lid may be provided to cover the opening.

The transportation device may be configured for moving the lid so as to enable the movable platform to enter the first and/or third storage section through the opening. The transportation device may provide engagement with the lid when the movable platform is moved down with respect to the frame.

For example, the transportation device may include a pin insertable into a slot on the lid when the movable platform is moved down with respect to the frame.

The transportation device may be transferred along the rails to move the lid when the engagement with the lid is provided.

In accordance with a method of the present disclosure, a customer is enabled to pick up ordered products including perishable items, using a transportation device movable along one or more horizontal rails provided in a storage system for storing containers arranged in multiple rows at various horizontal levels with respect to ground.

The storage system includes a first storage section arranged below the horizontal rails for storing containers with products at a first temperature and a second storage section for storing containers with products at a second temperature higher than the first temperature. The first storage section is covered with a thermal insulating cover. The rails are supported by vertical support elements arranged outside of the thermal insulating cover.

The transportation device includes a frame movable along the horizontal rails and a movable platform configured to move down with respect to the frame.

In response to a command from the customer, the transportation device is controlled for loading onto the movable platform one or more first containers with one or more first products ordered by the customer and stored in the first storage section, and one or more second containers with one or more second products ordered by the customer and stored in the second storage section.

The loading of the one or more first containers may include:
moving the transportation device along the horizontal rails to a position above an opening on top of the thermal insulating cover, and
moving the movable platform down with respect to the frame to enable the movable platform to enter the first storage section through the opening and take the one or more first containers.

The thermal insulating cover may include a lid covering the opening, and the transportation device may be controlled to open the lid so as to enable the movable platform to enter the first storage section, and to close the lid after the movable platform is moved up to exit the first storage section.

The movable platform may be moved down to provide engagement with the lid so as to open or close the lid.

The transportation device may be moved along the horizontal rails when the movable platform is engaged with the lid so as to open or close the lid.

After closing the lid, the movable platform may be moved up so as to enable the transportation device to move along the rails to a desired position.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 shows an exemplary embodiment of a robotic pickup point of the present disclosure.

FIG. 2 shows an exemplary arrangement of a storage module in accordance with the present disclosure.

FIG. 3 schematically illustrates an exemplary embodiment of the storage module with cooling chambers, and a robotic transportation device of the present disclosure.

FIGS. 4-7 illustrate an exemplary embodiment of the robotic transportation device in accordance with the present disclosure.

FIG. 8 is a simplified block diagram that illustrates elements for supporting various operations performed by the transportation device

FIG. 9 illustrates an exemplary storage module in more detail.

FIGS. 10-12 illustrate exemplary operations carried out to open a lid on the top of a cooling chamber in accordance with the present disclosure.

FIGS. 13-19 illustrate exemplary operations carried out to take containers with products from various sections of the storage module for delivery to a customer.

FIG. 20 illustrates exemplary elements of the robotic transportation device operating inside and outside of a cooling chamber in accordance with the present disclosure.

### DETAILED DISCLOSURE OF THE EMBODIMENTS

The present disclosure will be made using specific examples of a robotic pickup point for an order fulfillment system. It will become apparent, however, that the concept of the disclosure is applicable to any retail system for storing perishable and non-perishable items in multiple storage sections including cooling chambers.

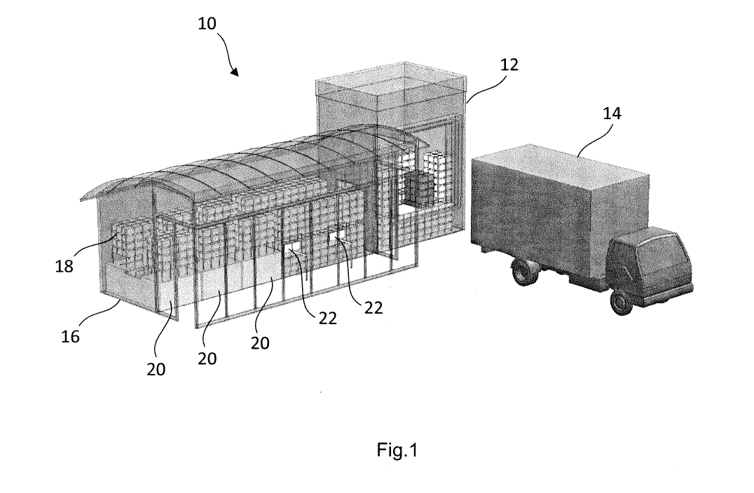

FIG. 1 schematically illustrates an exemplary robotic pickup point 10 of the present disclosure configured for enabling customers to pick up orders in an order fulfillment system. An order may be made, for example, online using a Website of a retailer and may include various products selected by a customer. After receiving the order, the retailer may prepare it in an order fulfilment facility and deliver the prepared order to the robotic pickup point 10 for storage. The customer notified that the order is delivered to a particular pickup point can pick up the order at the robotic pickup point 10 at a convenient time.

In accordance with an alternative embodiment of the present disclosure, the robotic pickup point 10 may receive a customer's order and fulfil the order using products stored in the pickup point 10. In this case, the customer can place an order at the robotic pickup point 10 that fulfils the order immediately and makes it available to the customer.

The robotic pickup point 10 may include a delivery module 12 configured for receiving orders or products delivered from a central facility. For example, orders or products may be delivered by trucks 14. Also, the robotic pickup point 10 may include a storage module 16 configured for storing orders waiting for pickup, or products used to prepare orders.

The storage module 16 may include multiple storage racks 18 including shelves for arranging containers in multiple rows at various horizontal levels with respect to the ground. The containers may be any objects capable of holding goods stored in the storage area, such as cartons, boxes, crates, or pallets. Some storage racks 18 may be arranged in separate cooling chambers 20 for storing perishable products such as food items. As perishable products must be stored at various temperatures, the cooling chambers 20 may include chambers configured for storing products at different temperatures. For example, the chambers 20 may include a freezing chamber for storing products at subfreezing temperatures in a range between −18° C. and −35° C., and two refrigerating chambers, one of which may be configured for storing products at temperatures just above freezing, e.g. between 1° C. and 5° C., and the other may be provided for storing products at higher temperatures, e.g. between 5° C. and 12° C.

For example, an order including products requiring storage at different temperatures may be delivered to the pickup point 10 in separate containers, one of which may include frozen food products to be stored in the freezing chamber, the second container may include food products for storing at temperatures just above freezing, the third container may include products that must be refrigerated at higher temperatures, and the fourth container may have products that do not require freezing or refrigeration. After delivery, the containers may be stored in the storage racks 18 arranged in the respective cooling chambers 20 or in the storage racks 18 outside of the cooling chambers 20.

The pickup point 10 includes at least one robotic transportation device that may unload delivered containers and place them into the storage racks 18 including the storage racks arranged in the cooling chambers 20. As discussed in more detail below, in response to a request from a customer entering the pickup point 10 to receive an order, the robotic transportation device is controlled to collect containers relating to the order from storage racks 18 inside and outside the cooling chambers 20, and deliver the containers to a delivery point. For example, the robotic transportation device may deliver containers with the ordered items to customers via pickup windows 22 provided in the storage module 16. Hence, the robotic pickup point 10 of the present disclosure is configured to serve customers with no human intervention.

In an alternative embodiment, in which the robotic pickup point 10 enables a customer to place an order and receive it immediately by fulfilling the customer's order using products stored in the storage module 16, the robotic transportation device may deliver containers storing order's items to a picking area in which a robotic picking device may fulfil the order by collecting items from different containers. An example of interactions between the transportation device and the picking device is disclosed in my copending US patent application Ser. No. 14/049,552 filed on Oct. 9, 2013 and entitled “AUTOMATIC ORDER PICKING SYSTEM AND METHOD IN RETAIL FACILITY,” incorporated herewith by reference.

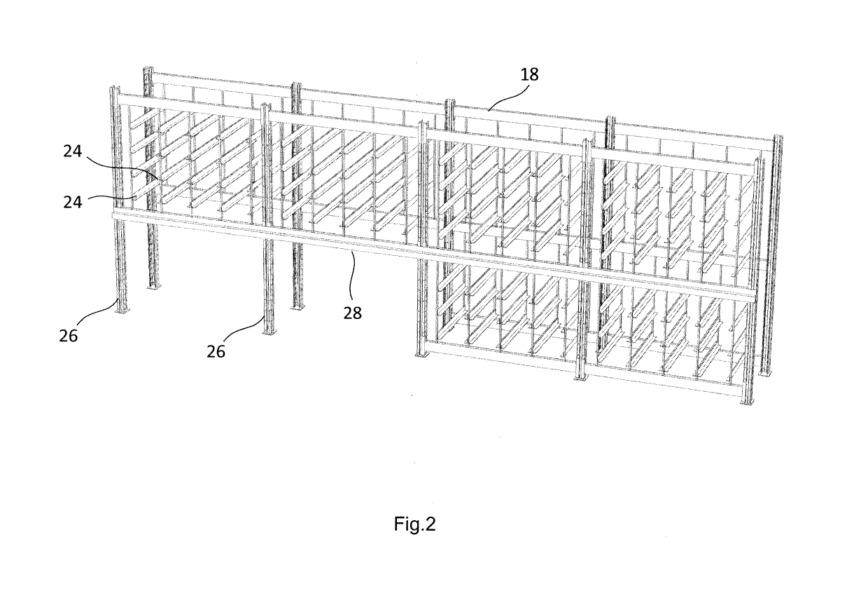

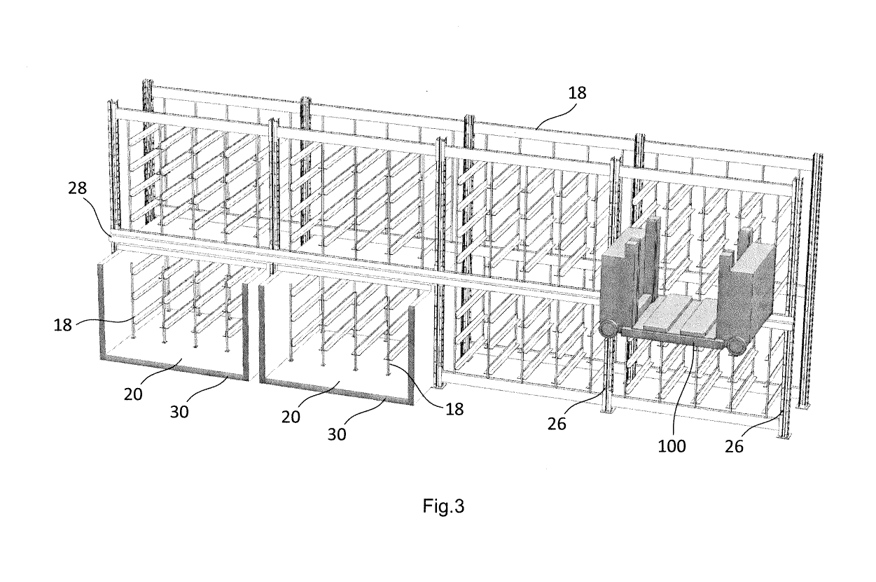

FIGS. 2 and 3 illustrate an exemplary arrangement of the storage racks 18 that can be used in the storage module 16. Each storage rack 18 includes shelves 24 configured to provide storage cells for holding containers in multiple rows at various horizontal levels with respect to the ground. The storage racks 18 may include vertical support columns 26 configured for supporting a pair of rails 28 used for moving a robotic transportation device 100 (FIG. 3) in a passage between adjacent racks 18. The support columns 26 and the rails 28 may be made of strong metals. For clarity, FIGS. 2 and 3 do not show the second rail 28 in a pair of rails used for moving the transportation device 100. The second rail 28 is supported by vertical support columns 26 arranged across the passage between the racks 18. The transportation device 100 and its operations are discussed below.

FIG. 2 illustrates areas for arranging the cooling chambers 20. FIG. 3 shows the cooling chambers 20 provided in these areas below the rails 28. Each cooling chamber 20 may contain storage racks 18 arranged inside a thermal insulating cover 30. FIG. 3 showing a cross section of the cooling chambers 20 with the respective storage racks 18 provided inside the chambers covered by the thermal insulating covers 30. As discussed in more detail later, the thermal insulating cover 30 of each cooling chamber 20 includes an opening on top of the cover to allow a movable platform of the robotic transportation device 100 to enter the chamber. A removable lid may be provided to cover this opening.

To prevent thermal bridging causing multi-dimensional heat transfer between areas inside the cooling chambers 20 and areas outside of the cooling chambers 20, the vertical support columns 26 and horizontal rails 28 are arranged outside of the thermal insulating covers 30 of the cooling chambers 20. Also, to prevent the thermal bridging, the storage racks 18 arranged inside a particular cooling chamber 20 are physically isolated from the storage racks 18 provided outside of the chamber 20.

As a result, forming ice on the rails 28 is prevented making it possible to use the rails 28 for moving the robotic transportation device 100. In addition, by preventing the thermal bridging, the arrangement of the storage module 16 makes it possible to prevent exposure of products stored inside and outside of the cooling chambers 20 to high humidity due to condensation typically occurring in regions between colder and warmer areas.

Further, by providing the thermal bridge free arrangement of the storage module 16, stored products are prevented from exposure to undesired temperature variations inside and outside of the cooling chambers 20 caused by multi-dimensional heat transfer associated with the thermal bridge. In addition, corrosion of metal elements in the storage module 16 and the transportation device 100 is prevented.

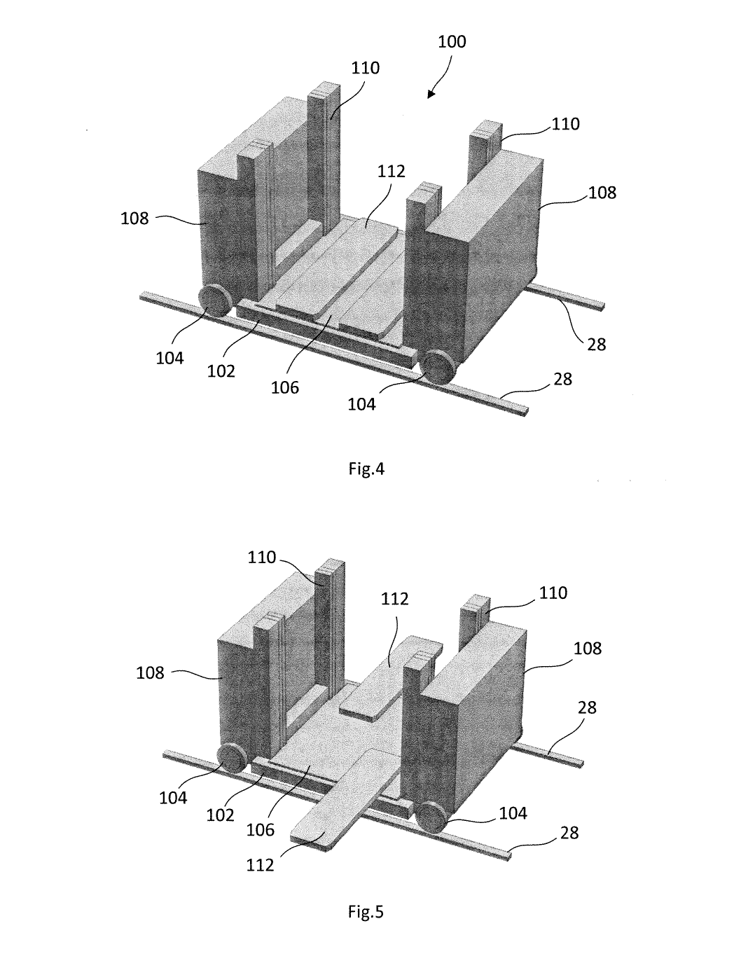

FIGS. 4-7 schematically illustrate an exemplary embodiment of the robotic transportation device 100 that may be used in the pickup point 10. As shown in FIG. 4, a robotic transportation device 100 may include a frame 102 with four wheels 104 fixed to the frame 102 which may be formed as a braced structure for supporting elements required to operate the transportation device 100. Each wheel 104 may be attached to the frame 102 so as to rotate in a vertical plane about an axis extending from the center of the wheel 104 in order to move the transportation device 100 along the rails 28.

The frame 102 may hold a movable platform 106 that can be used for carrying containers. For example, the platform 106 may be a rectangular metal plate configured to accommodate containers. Side walls 108 may be provided on the frame 102 to support loading and carrying containers.

The platform 106 may move in a vertical direction up and down with respect to the frame 102 so as to access containers arranged in rows above and below the level at which the rails 28 are arranged. A platform lifting mechanism 110 may be arranged at the side walls 108 to move the platform 106 in a vertical direction. The platform lifting mechanism 110 may be implemented using any well-known mechanisms for moving a plate up and down. For example, a telescopic mechanism can be utilized.

One or more handling elements 112 may be mounted on the platform 106 and configured for operating with containers. The handling elements 112 may take one or more containers from the storage rack 18, place the containers onto the transportation device 100 for carrying to another location, and remove the container from the transportation device 100 for placing it at a desired location. The handling elements 112 may be extended in a horizontal direction from both sides of the transportation device 100 so as to handle containers arranged at storage racks at both sides of the passage along which the rails 28 are provided. For example, the handling elements 112 may be implemented as a metal plate, spade, fork or pulling device.

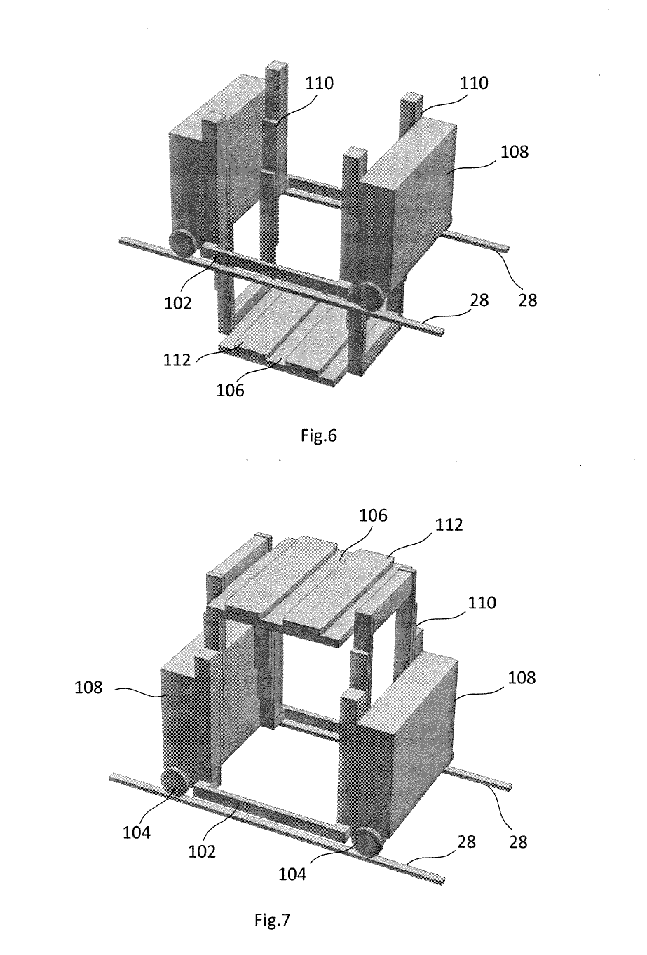

FIG. 5 illustrates the robotic transportation device 100 with the handling elements 112 extended from both sides of the transportation device 100. FIG. 6 illustrates the transportation device 100 with the movable platform 106 moved down with respect to the frame 102 so as to handle containers arranged in rows below the level of the rails 28. FIG. 7 illustrates the transportation device 100 with the movable platform 106 raised with respect to the frame 102 so as to handle containers arranged in rows above the level of the rails 28.

FIGS. 4-7 show a robotic transportation device 100 having the wheels 104 attached at the lower portion of the frame 102. However, the wheels 104 may be attached at the upper portion of the frame 102 or at the middle portion of the frame 102.

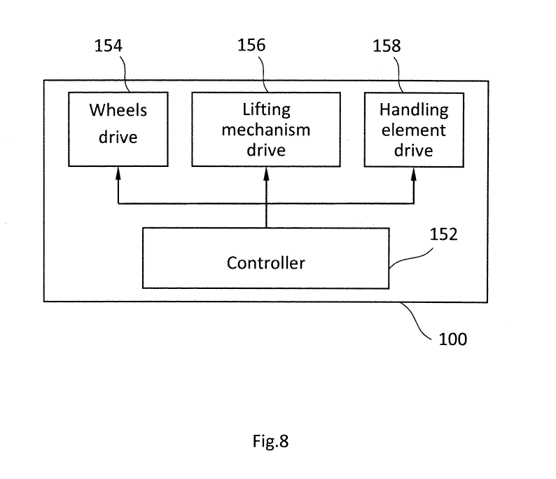

FIG. 8 is a simplified block diagram that illustrates elements for supporting various operations performed by the transportation device 100. The operations of the transportation device 100 are controlled by a controller 152 that may include a data processor responsive to external commands for processing the commands and producing various control signals. The controller 152 may be provided on the frame 102 and may communicate with various elements of the transportation device 100 to supply control signals to the elements of the transportation device 100 and receive responses.

In particular, the controller 152 may control a wheels drive 154, a platform lifting mechanism drive 156 and a handling element drive 158. The wheels drive 154 and the platform lifting mechanism drive 156 may be arranged on the frame 102, whereas the handling element drive 158 may be arranged on the movable platform 106.

The wheels drive 154 is provided for driving the wheels 104 so as to rotate them in a vertical plane in order to move the transportation device 100 along the rails 28 in a horizontal direction. The wheels drive 154 may be implemented using any of well-known mechanisms for rotating wheels.

The platform lifting mechanism drive 156 is provided for driving the platform lifting mechanism 110 that move the platform 106 up and down in a vertical direction. The platform lifting drive 156 may be implemented using any well-known mechanisms for moving a plate up and down. For example, telescopic mechanisms can be utilized.

The handling element drive 158 is provided for extending the handling element 112 from a desired side of the transportation device 100 so as to enable the handling element 112 to operate with a container. For example, the handling element drive 158 may be implemented using a telescopic linear actuator.

An exemplary transportation device that can be used as a robotic transportation device 100 in the pickup point 10 is also described in my copending U.S. patent application Ser. No. 14/049,552 filed on Oct. 9, 2013 and entitled “AUTOMATIC ORDER PICKING SYSTEM AND METHOD IN RETAIL FACILITY,” in my copending U.S. patent application Ser. No. 14/155,976 filed on Jan. 15, 2014 and entitled “TRANSFERRING CONTAINERS IN STORAGE SYSTEM,” and in my copending application Ser. No. 14/178,024, filed on Feb. 11, 2014 and entitled “MULTI-LEVEL STORAGE SYSTEM WITH TRANSPORTATION DEVICES MOVABLE IN SUBSTANTIALLY PERPENDICULAR DIRECTIONS AND METHOD OF TRANSFERRING CONTAINERS IN DESIRED SEQUENCE,” all of which are incorporated herewith by reference.

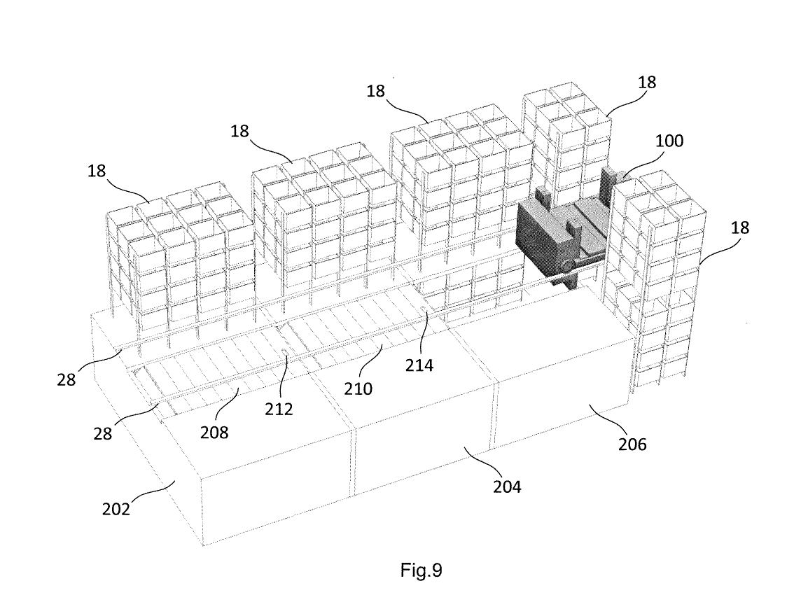

Referring to FIG. 9 that illustrates an exemplary embodiment of the robotic picking point 10 of the present disclosure, the robotic transportation device 100 is configured for moving along the horizontal rails 28 extending in a passage between the storage racks 18. As discussed above, some of the storage racks 18 are provided in the cooling chambers 20 covered by thermal insulating covers. For example, the cooling chambers in FIG. 9 include a freezing chamber 202, a refrigerating chamber 204 and a refrigerating chamber 206. The freezing chamber 202 may store products at a subfreezing temperature selected from a range between −18° C. and −35° C. The refrigerating chamber 204 may store products at a temperature, which is just above freezing, for example, selected from a range between 1° C. and 5° C., and the refrigerating chamber 206 may be provided for storing products at a higher temperature, e.g. selected from a range between 5° C. and 12° C.

The chambers 202, 204 and 206 are provided below the rails 28. The thermal insulating cover covering the storage racks in each of the chambers 202, 204 and 206 have openings on the top of the covers provided to enable the movable platform of the transportation device 100 to enter the respective chamber when the transportation device 100 is positioned above the chamber and the movable platform 106 is moved down with respect to the frame 102. Due to reduced upward heat transfer from colder areas to warmer areas, the arrangement of the cooling chambers below the path, at which the transportation device 100 moves, makes it possible to reduce the exposure of products carried by the transportation device 100 and elements of the transportation device 100 to temperatures of the cooling chambers.

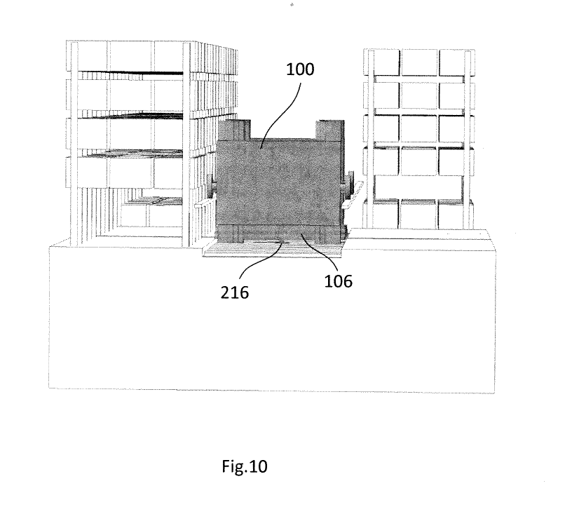

The opening on the top of the thermal insulating cover may be covered by a removable lid. For example, the opening on the top of the freezing chamber 202 may be covered by a folding lid 208 and the opening of the refrigerating chamber 204 may be covered by a folding lid 210. The folding lids 208 and 210 may include slots 212 and 214 configured for receiving a pin 216 (FIG. 10) provided on the bottom surface of the movable platform 106 in the transportation device 100.

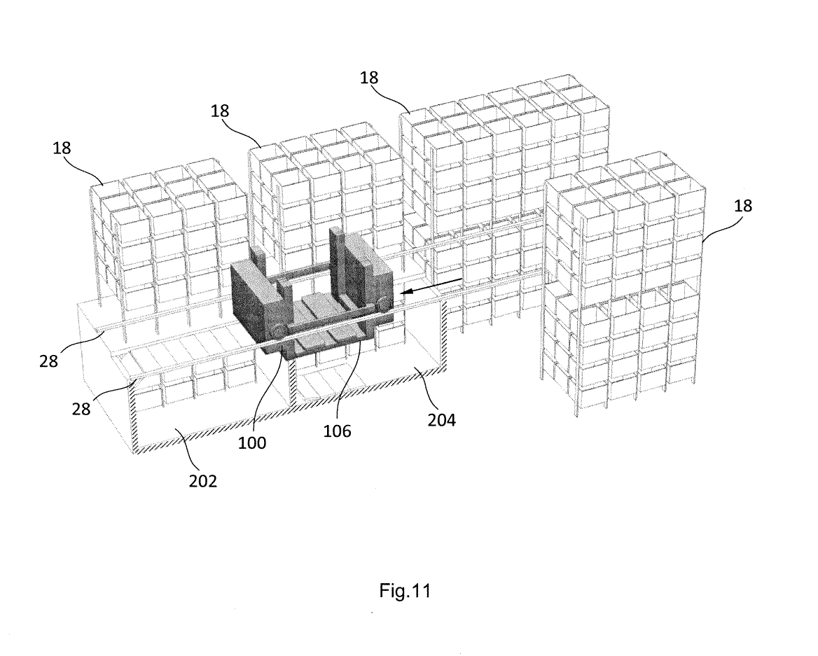

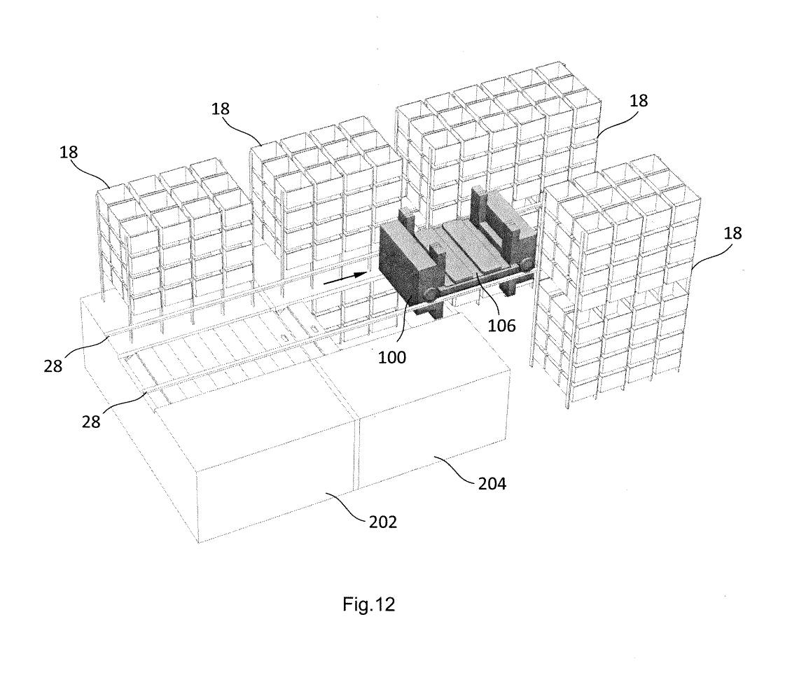

As illustrated in FIGS. 10 and 11, the transportation device 100 may be moved along the rails 28 to position the pin 216 above the slot on the lid being removed. For example, FIG. 11 illustrates removal of the lid 210. When the pin 216 is positioned above the slot 214, the movable platform 106 is moved down to insert the pin 216 into the slot 214. Then, the transportation device 100 is moved along the rails 28 to fold the lid 210 so as to provide opening in the refrigerating chamber 204. As shown in FIG. 12, after the lid 210 is folded, the movable platform 106 is moved up to allow the transportation device 100 to move along the rails 28 to a position required to take desired containers from the refrigerating chamber 204.

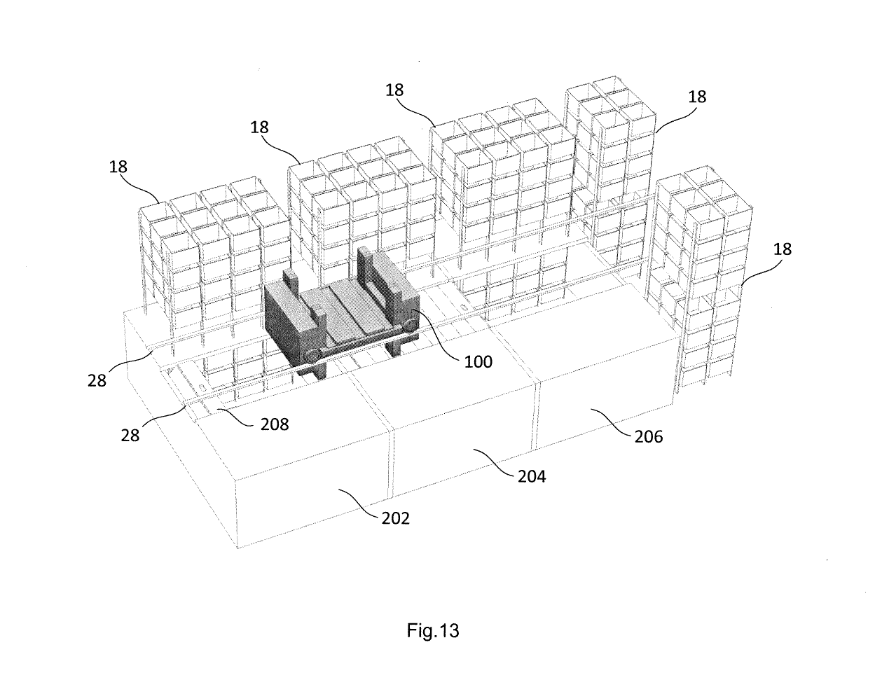

FIGS. 13-19 illustrate exemplary operations performed to collect containers from various sections of the storage module 16. When a customer enters the robotic pickup point 10 to receive an order, she may identify the order using a data input device. For example, a credit card reader may be arranged at the pickup point 10 to identify the order by a credit card used for ordering. Information identifying the order is transferred to a control unit that may include a data processor responsive to external commands for processing the commands and producing various control signals. The control unit may communicate with the controller 152 of the robotic transportation device 100 to supply control signals to the elements of the transportation device 100 and receive responses. The control unit may be arranged at the robotic pickup point 10. Alternatively, information identifying the order may be transferred to a remote central control unit configured for controlling the robotic transportation devices 100 at multiple pickup points 10.

In response to the information identifying a particular order, the robotic transportation device 100 is provided with data on locations of containers relating to that order. For example, products ordered by the customer may be stored in three containers, one of which is located in the freezing chamber 202, the second container may be stored in the refrigerating chamber 204 and the third container may be located in the refrigerating chamber 206. The robotic transportation device 100 may be instructed to collect these containers in any desired sequence.

For example, as illustrated in FIG. 13, the transportation device 100 may be moved along the rails 28 to a position above the freezing chamber 202 selected so as to place the pin 216 above the slot 212 in the folding lid 208 covering the opening on top of the chamber 202. Then, the movable platform 106 is moved down to insert the pin 216 into the slot 212, and the transportation device 100 is moved along the rails 28 to fold the lid 208 so as to provide opening for entering the freezing chamber 202. When the lid 208 is folded, the movable platform 106 is moved up with respect to the frame 102, and the transportation device 100 is moved along the rails 28 to a selected position corresponding to a location of a selected container stored in the freezing chamber 202.

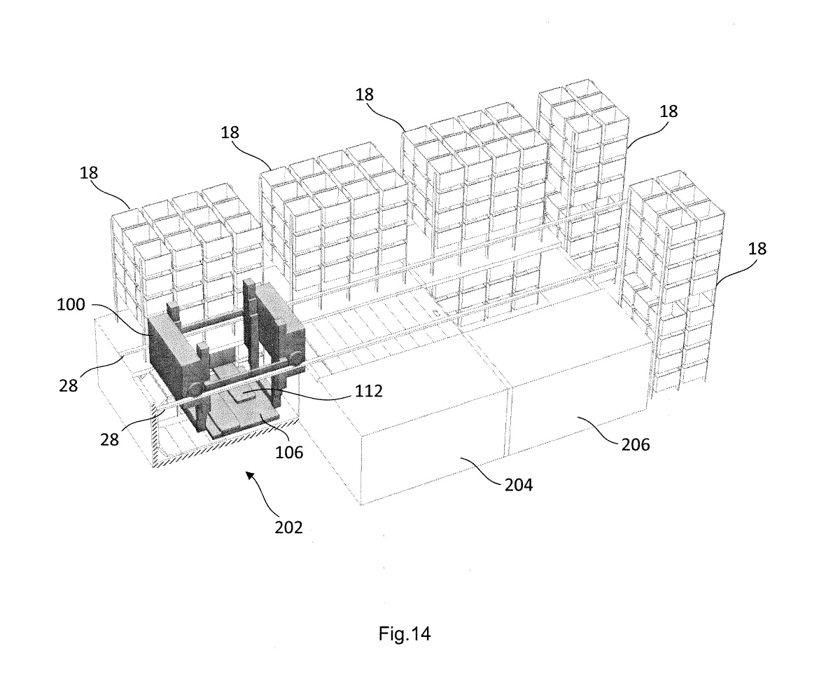

Referring to FIG. 14 schematically illustrating the cross section of the freezing chamber 202, when the selected position is reached, the movable platform 106 is moved down to a level corresponding to the vertical level at which the selected container is stored in the freezing chamber 202. The selected container is taken from the storage cell using a holding element 112 of the transportation device 100 and placed onto the movable platform 106.

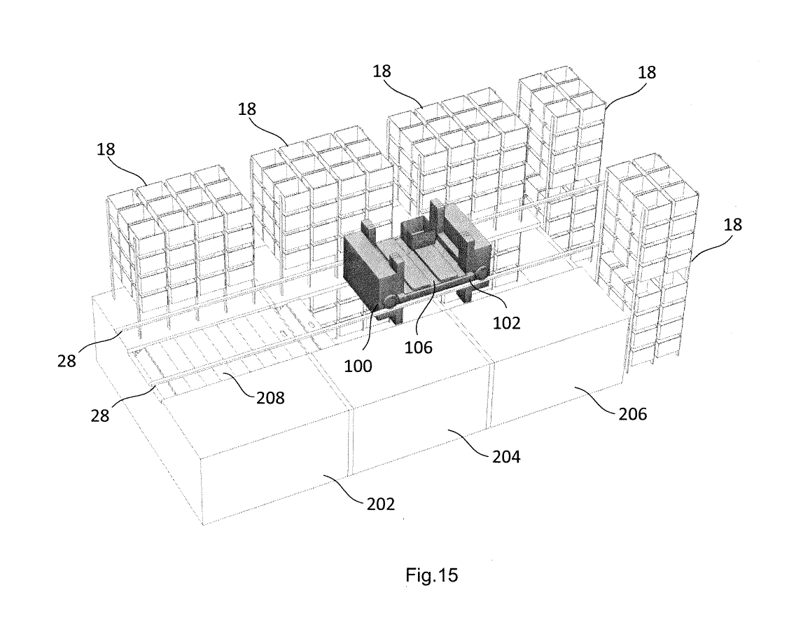

Referring to FIG. 15, after the container is placed onto the platform 106, the platform 106 is moved up with respect to the frame 102 to enable the robotic transportation device 100 to move along the rails 28 to a position at which the pin 216 is located above the slot 212 of the folded lid 208. The movable platform 106 is moved down to insert the pin 216 into the slot 212, and the transportation device 100 is moved along the rails 28 to unfold the lid 208 so as to close the opening on the top of the freezing chamber 202.

Then, the movable platform 106 is moved up to enable the transportation device 100 carrying a container to move along the rails 28 to a position at which the pin 216 is located above the slot 214 of the folding lid 210 covering the opening on top of the refrigerating chamber 204. After the lid 210 is folded in a manner discussed above, the transportation device 100 is moved along the rails 28 to a selected position corresponding to the location of the selected container stored in the refrigerating chamber 204.

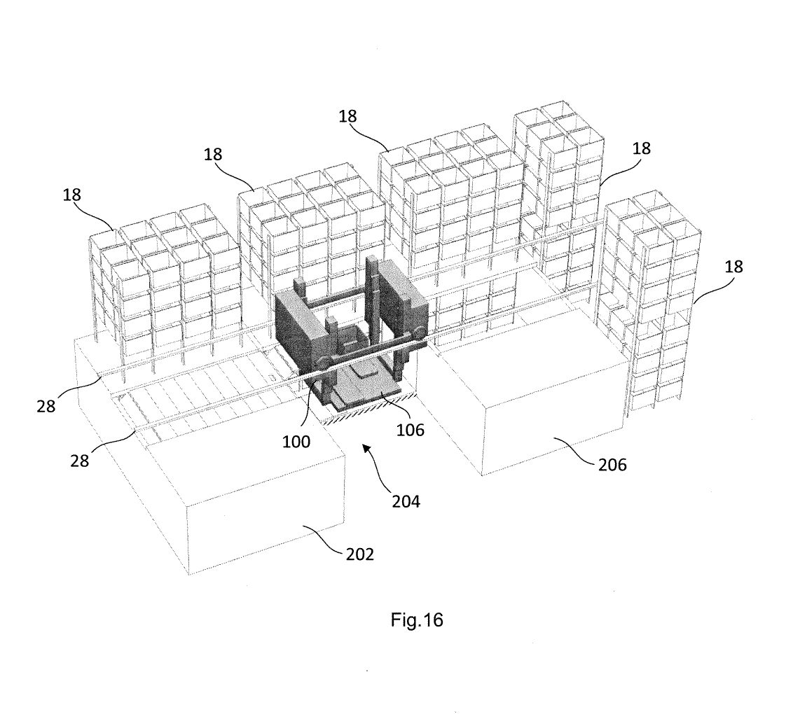

Referring to FIG. 16 schematically illustrating the cross section of the refrigerating chamber 204, when the selected position is reached, the movable platform 106 is moved down to a level corresponding to the vertical level at which the selected container is stored in the refrigerating chamber 204. The selected container is taken using a holding element of the transportation device 100 and placed onto the movable platform 106 next to the container collected from the chamber 202.

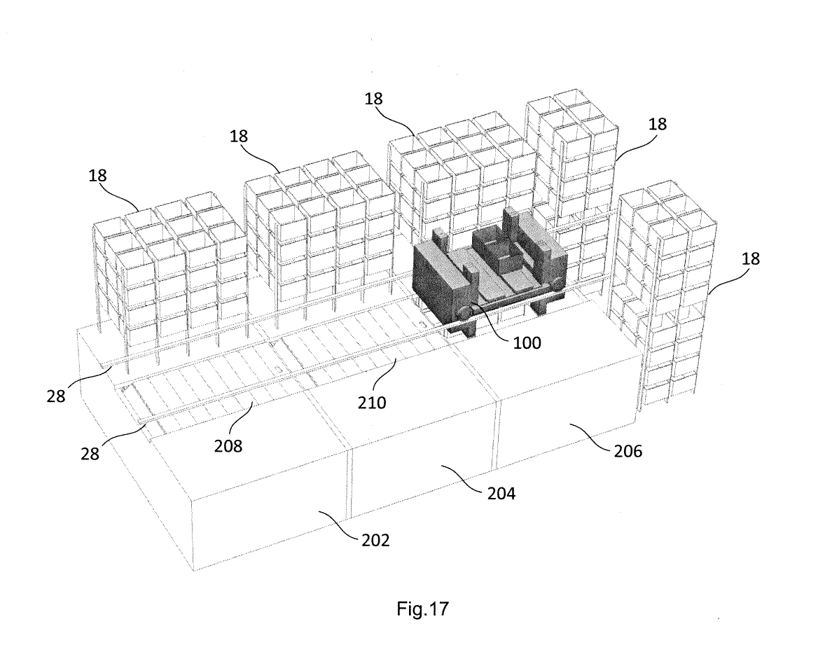

Referring to FIG. 17, the movable platform 106 with two containers is moved up, and the transportation device 100 is moved along the rails 28 to unfold the lid 210 in a manner discussed above, so as to close the opening on top of the refrigerating chamber 204. When the lid 210 is unfolded, the movable platform 106 is moved up with respect to the frame 102, and the transportation device 100 is moved along the rails 28 to a selected position corresponding to a location of a selected container stored in the refrigerating chamber 206 that does not have a lid covering its opening.

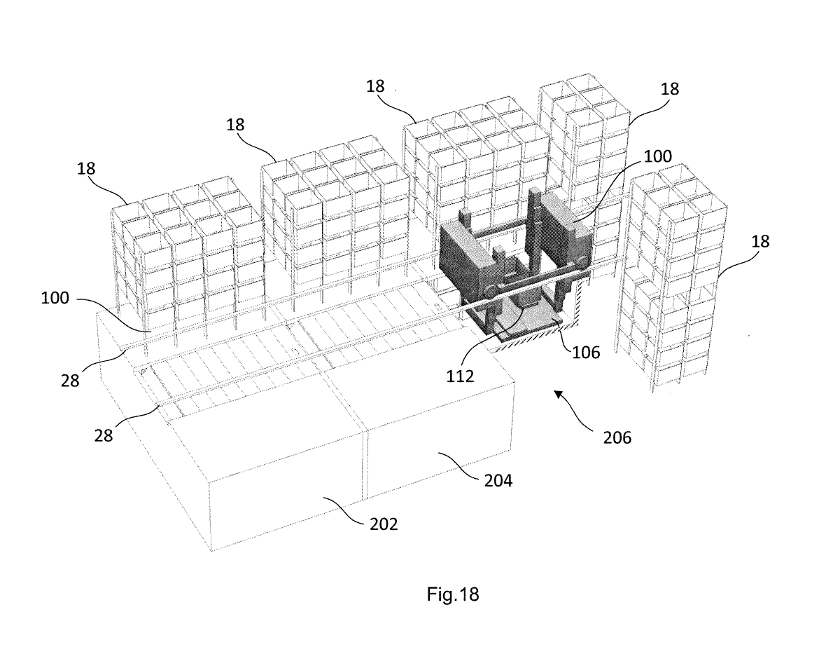

Referring to FIG. 18 schematically illustrating the cross section of the refrigerating chamber 206, when the selected position is reached, the movable platform 106 is moved down to a level corresponding to the vertical level at which the selected container is stored in the refrigerating chamber 206. The selected container is taken using a holding element of the transportation device 100 and placed onto the movable platform 106 next to the containers collected from the chambers 202 and 204.

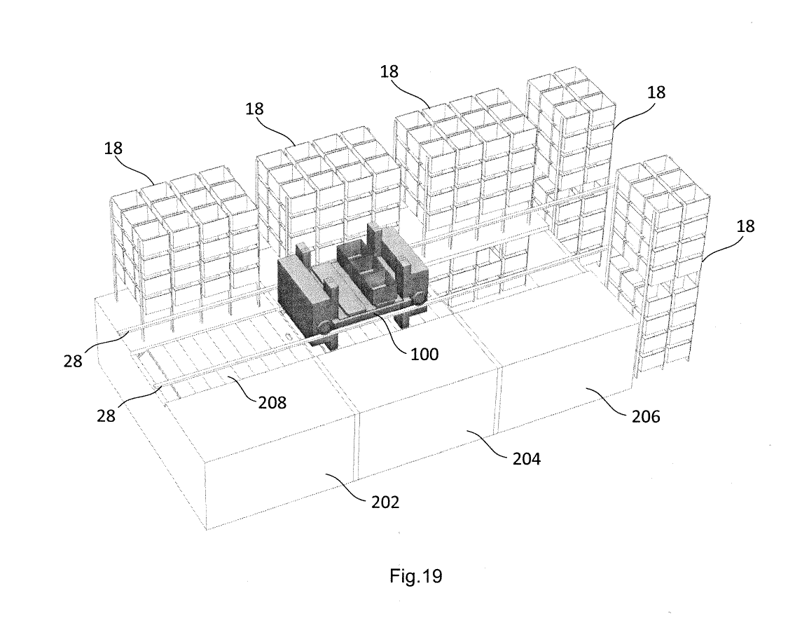

Referring to FIG. 19, the movable platform 106 with three containers is moved up to enable the transportation device 100 carrying three collected containers to move along the rails 28 to a desired position from which the containers can be transferred to the customer. For example, the collected containers relating to the customer's order can be transferred to the customer via the pickup window 22.

In a similar manner, any containers may be collected from various storage racks 18 arranged above or below the rails 28. If a particular container is stored in a storage rack 18 above the rails 28, the transportation device 100 is controlled to move the movable platform 106 up with respect to the frame 102 to a level corresponding to the vertical level at which the container is arranged.

As discussed above, cooling chambers 20 including freezing chambers and refrigerating chambers are arranged below the rails 28 in order to reduce exposure of transportation device's elements and products carried by the transportation device 100 to variations of temperatures associated with different cooling chambers.

In particular, due to a reduced upward flow of heat from colder areas to warmer areas, products carried by the transportation device along the rails 28 are practically not exposed to heat flows from the colder areas below the rails 28. Moreover, the system of the present disclosure makes it possible to reduce the time during which the movable platform 106 with products is positioned inside a particular cooling chamber. As a result, the products collected from outside of a particular chamber and carried by the movable platform 106 are exposed to the temperature of the particular cooling chamber only for a very short period of time. Hence, the exposure of products to different temperatures is minimized.

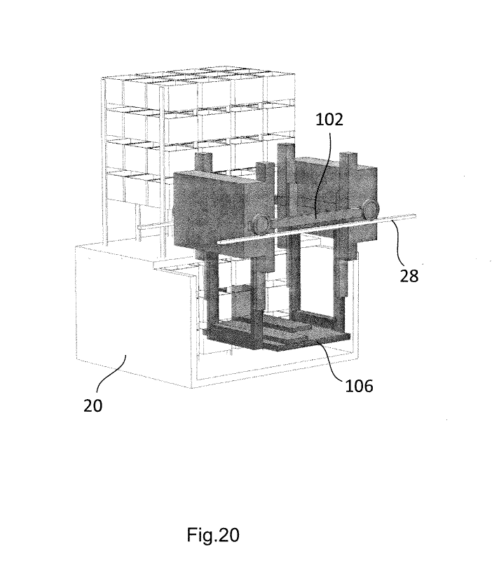

Further, as illustrated in FIG. 20, the transportation device 100 is configured so as to arrange most temperature sensitive elements, such as the controller 152, on the frame 102 which does not enter cooling chambers 20. Only a minimum number of elements are associated with the movable platform 106 exposed to low temperatures for a very short time period. Hence, the system of the present disclosure makes it possible to minimize exposure of transportation device's elements to different temperatures associated with the cooling chambers 20.

Moreover, as discussed above, the arrangement of the present disclosure makes it possible to prevent thermal bridging between interior and exterior areas of cooling chambers. As a result, forming ice on the rails 28 is prevented making it possible to use the rails 28 for moving the robotic transportation device 100. Also, the thermal bridge free arrangement provided in accordance with the present disclosure prevents exposure of products stored inside and outside of the cooling chambers 20 to high humidity and uncontrolled temperature variations due to multi-dimensional heat transfer associated with the thermal bridge. In addition, corrosion of metal elements in the storage module 16 and the transportation device 100 is prevented.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein.

What is claimed is:

1. A retail facility for enabling customers to pick up products including perishable items, the retail facility comprising:
a storage system for storing containers arranged in multiple rows at various horizontal levels with respect to ground, the storage system including a first storage section for storing containers with products at a first temperature and a second storage section for storing containers with products at a second temperature higher than the first temperature, the first storage section being covered with a first thermal insulating cover, and
a transportation device movable along one or more horizontal rails arranged above the first storage section, the rails being supported by vertical support elements arranged outside of the first thermal insulating cover, the transportation device being configured for taking one or more containers stored in the storage system and delivering the containers to a selected destination, the transportation device including a frame movable along the horizontal rails and a movable platform configured to move down with respect to the frame to take one or more containers arranged at horizontal levels below the horizontal rails.

2. The retail facility of claim 1, wherein:
the storage system includes a third storage section for storing containers with products at a third temperature higher than the first temperature but lower than the second temperature,
the third section is arranged below the horizontal rails, and is covered with a second thermal insulating cover, and
the vertical support elements for supporting the horizontal rails are arranged outside of the second thermal insulating cover.

3. The retail facility of claim 1, wherein the movable platform is further configured to move up with respect to the frame to take one or more containers arranged at horizontal levels above the horizontal rails.

4. The retail facility of claim 1, wherein:
the first thermal insulating cover includes an opening on top of the cover to allow the movable platform to enter the first storage section, and a lid covering the opening, and
the transportation device is configured for moving the lid so as to enable the movable platform to enter the first storage section through the opening.

5. The retail facility of claim 4, wherein the transportation device is configured to provide engagement with the lid when the movable platform is moved down with respect to the frame.

6. The retail facility of claim 5, wherein the transportation device includes a pin insertable into a slot on the lid when the movable platform is moved down with respect to the frame.

7. The retail facility of claim 5, wherein the transportation device is transferred along the rails to move the lid when the engagement with the lid is provided.

8. A method of enabling a customer to pick up ordered products including perishable items, using a transportation device movable along one or more horizontal rails provided in a storage system for storing containers arranged in multiple rows at various horizontal levels with respect to ground, the storage system including a first storage section arranged below the horizontal rails for storing containers with products at a first temperature and a second storage section for storing containers with products at a second temperature higher than the first temperature, the first storage section being covered with a thermal insulating cover, the rails being supported by vertical support elements arranged outside of the thermal insulating cover, the transportation device including a frame movable along the horizontal rails and a movable platform configured to move down with respect to the frame; the method comprising:
in response to a command from the customer, controlling the transportation device for loading onto the movable platform one or more first containers with one or more first products ordered by the customer and stored in the first storage section, and one or more second containers with one or more second products ordered by the customer and stored in the second storage section,
wherein loading of the one or more first containers includes:
moving the transportation device along the horizontal rails to a position above the first storage section, and
moving the movable platform down with respect to the frame to enable the movable platform to take the one or more first containers from the first storage section through an opening in the thermal insulating cover.

9. The method of claim 8, wherein
the thermal insulating cover includes a lid covering the opening, and the transportation device is controlled to open the lid so as to enable the movable platform to enter the first storage section, and to close the lid after the movable platform is moved up to exit the first storage section.

10. The method of claim 9, further comprising the step of moving the movable platform down to provide engagement with the lid so as to open or close the lid.

11. The method of claim 10, further comprising the step of moving the transportation device along the rails when the movable platform is engaged with the lid so as to open or close the lid.

12. The method of claim 11, further comprising the step of moving the movable platform up after closing the lid so as to enable the transportation device to move along the rails to a desired position.
